(19) United States
(12) Patent Application Publication
(10) Pub. No.: US 2005/0243295 A1
(43) Pub. Date: Nov. 3, 2005

(54) Lithographic apparatus and device manufacturing

(75) Inventors: Pieter Willem Herman de Jager, Rotterdam (NL); Cheng-Qun Gui, Best (NL)

Correspondence Address: STERNE, KESSLER, GOLDSTEIN & FOX PLLC, 1100 NEW YORK AVENUE, N.W., WASHINGTON, DC, 20005, US

(73) Assignee: ASML Netherlands B.V.

(21) Appl. No.: 10/835,601

(22) Filed: Apr. 30, 2004

(51) Int. Cl. G03B 27/52

(52) U.S. Cl. 355/55; 355/53; 355/67

(57) ABSTRACT

A lithographic apparatus and method project a patterned beam of radiation onto a substrate supported by a substrate table. The pattern is imparted to the beam using a patterning system. The patterned beam is projected onto a target portion of the substrate by a projection system. The projection system defines a pupil between the patterning system and the substrate table. A series of lens components are located between the pupil and the substrate table. The lens components comprise a beam expander, for expanding the beam from the pupil, and an array of lenses extending transversely relative to the beam such that each lens of the array focuses a respective portion of the projection beam onto a respective part of the target portion of the substrate. The position of at least one of the lens components is adjusted to adjust the magnification of the projection system.

### BACKGROUND

1. Field of the Invention

The present invention relates to a lithographic apparatus and a device manufacturing method.

2. Related Art

A lithographic apparatus is a machine that applies a desired pattern onto a target portion of a substrate. The lithographic apparatus can be used, for example, in the manufacture of integrated circuits (ICs), flat panel displays and other devices involving fine structures. In a conventional lithographic apparatus, a patterning device, which is alternatively referred to as a mask or a reticle, may be used to generate a circuit pattern corresponding to an individual layer of the IC (or other device). This pattern can be imaged onto a target portion (e.g., part of one or several dies) on a substrate (e.g., a silicon wafer or glass plate) that has a layer of radiation-sensitive material (e.g., resist). Instead of a mask, the patterning device may comprise an array of individually controllable elements that generate the circuit pattern.

In general, a single substrate will contain a network of adjacent target portions that are successively exposed. Known lithographic apparatus include steppers, in which each target portion is irradiated by exposing an entire pattern onto the target portion in one go, and scanners, in which each target portion is irradiated by scanning the pattern through the projection beam in a given direction (e.g., the “scanning” direction), while synchronously scanning the substrate parallel or anti parallel to this direction. In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the projection beam in a given direction (the “scanning”-direction) while synchronously scanning the substrate parallel or anti-parallel to this direction.

It will be appreciated that, whether or not a lithographic apparatus operates in stepping or scanning mode, it is vital that the patterned beam is directed onto the appropriate target portion of the substrate surface. In many circumstances multi-layer structures are built up on the surface of the substrate as a result of a sequence of lithographic processing steps. The successive layers formed in the substrate should be correctly aligned with each other. Thus, great care is taken to ensure that the position of the substrate relative to the beam projection system is accurately known, and that the magnification of the pattern at the surface of the substrate is tightly controlled. Generally, it is desirable to obtain a fixed magnification, but in some circumstances, for example when measurements indicate minor distortion of a substrate between successive processing steps, it is desirable to be able to adjust the magnification. This is particularly the case when processing very large substrates where substrate distortion of even a very small percentage amount can result in displacements that are significant in terms of the quality and reliability of manufactured devices.

In a microlens array (MLA) system, arrays of lenses are arranged so that each lens in the array projects a respective spot of light onto the substrate. A patterned beam is projected onto a microlens array through a beam expander. The beam expander is designed to produce a substantially parallel radiation beam that is directed towards a substrate. The microlens array is located between the beam expander and the substrate. Each lens of the microlens array focuses a respective portion of the parallel beam onto a respective part of the target portion of the substrate. Thus, the microlens array images an array of pixels on the substrate resulting in a series of spots of radiation projected onto the substrate.

The pitch of the spots is directly related to the pitch of the lenses in the microlens array. Any lens displacements will result in loss of focus at the substrate surface, and hence loss of resolution. Previously, magnification by displacement of the microlens array or the field lens has not been used. This inability to adjust the magnification in microlens array systems has been seen as a substantial drawback with such systems.

Therefore, what is needed is a system and method that can provide adjustment of a magnification of a microlens array using appropriate lens displacements.

### SUMMARY

According to one embodiment of the present invention, there is provided a lithographic apparatus comprising an illumination system for supplying a projection beam of radiation, a patterning system serving to impart to the projection beam a pattern in its cross section, a substrate table for supporting a substrate, and a projection system for projecting the patterned beam onto a target portion of the substrate. The projection system defines a pupil between the patterning system and the substrate table. The projection system comprises a series of lens components located between the pupil and the substrate table. The lens components comprise a beam expander for expanding the beam from the pupil and an array of lenses extending transversely relative to the beam, such that each lens of the array focuses a respective portion of the projection beam onto a respective part of the target portion of the substrate. The position of at least one of the lens components is adjustable relative to the pupil to adjust the magnification of the projection system.

According to another embodiment of the invention, there is provided a device manufacturing method comprising the steps of providing a substrate, providing a projection beam of radiation using an illumination system, using a patterning system to impart to the projection beam a pattern in its cross section, projecting the patterned beam of radiation onto a target portion of the substrate through a projection system defining a pupil and comprising a series of lens components located between the pupil and the substrate table. The lens components comprise a beam expander for expanding the beam from the pupil and an array of lenses extending transversely relative to the beam, such that each lens in the array focuses a respective part of the target portion of the substrate. The method also performs adjusting of the magnification of the projection system by adjusting the position of at least one of the lens components relative to the pupil.

At least one lens component of the beam expander may be displaceable relative to the pupil and the lens array, or the lens array may be displaceable relative to the pupil and the beam expander, or both the lens array and at least one component of the beam expander may be displaceable relative to the pupil.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 depicts a lithographic apparatus, according to a first embodiment of the present invention.

FIG. 2 is a more detailed illustration of FIG. 1, according to one embodiment of the present invention.

FIG. 3 is a schematic representation of an array of spatial light modulators, according to one embodiment of the present invention.

FIG. 4 is a perspective view of displaceable elements in the spatial light modulator assembly of FIG. 3.

FIG. 5 is a schematic representation of a single element of the spatial light modulator of FIG. 3.

FIGS. 6 and 7 illustrate the alternative states of a single element of a spatial light modulator as illustrated in FIG. 3.

FIG. 8 is a perspective view of a microlens array, according to an embodiment of the present invention.

FIG. 9 is a schematic representation of the exposure principle relied upon when using a microlens array, according to one embodiment of the present invention.

FIG. 10 is a schematic representation of a field lens, microlens, and substrate assuming a nominal magnification configuration, according to one embodiment of the present invention.

FIG. 11 is a top view of a micro lens array showing the position of projected image spots at nominal magnification, according to one embodiment of the present invention.

FIG. 12 corresponds to FIG. 10 but after a displacement of the field lens to reduce the magnification.

FIG. 13 is a top view of the micro lens array showing the position of image spots at reduced magnification after displacement of the field lens as shown in FIG. 12.

FIG. 14 corresponds to FIG. 10 but after a displacement of the field lens to produce a higher magnification.

FIG. 15 is top view of the micro lens array showing the position of image spots at increased magnification after displacement of the field lens as shown in FIG. 14.

FIG. 16 is a schematic representation of field lens, microlens and substrate showing the result of change in the inclination of the field lens to the microlens array, according to one embodiment of the present invention.

FIG. 17 is a flow diagram representing the magnification measurement and adjustment process, according to one embodiment of the present invention.

The present invention will now be described with reference to the accompanying drawings. In the drawings, like reference numbers may indicate identical or functionally similar elements.

### DETAILED DESCRIPTION OF THE EMBODIMENTS

Overview and Terminology

In one embodiment of the present invention using a microlens array imaging system, it is the function of a field lens of a beam expander (which field lens may be formed from two or more separate lenses) in an illumination system to make a projection system telecentric by ensuring that all components of the light beam between the field lens and the microlens array are parallel and perpendicular to the microlens array. However, although light beams between the field lens and the microlens array may be substantially parallel, absolute parallelism may not be achievable.

Thus, given a degree of non-telecentricity in the projection system, according to one embodiment of the present invention, small magnification adjustments can be achieved without undue loss of focus by displacing one or more of the lens components which are located between the pupil and the substrate table.

In one embodiment, a projection system will define a pupil. The term “pupil” being used in this document to refer to a plane where rays of the projection beam intersect which rays leave the patterning system from different locations relative to the patterning system but at the same angle relative to an axis of the projection beam which is normal to the patterning system.

For example, according to one embodiment of the present invention, assuming a microlens imaging system in which the field lens is initially arranged to generate a perfectly parallel beam of radiation between itself and the array of lenses. Also, assume that light reaching the field lens is diverging. Any displacement of the field lens away from the microlens array will result in the projection beam becoming slightly divergent, whereas displacement of the field lens towards the microlens array will result in the projection beam becoming slightly convergent. Given however that the field lens is a relatively weak lens, displacements necessary to change the magnification of the projection system to compensate for distortions of the substrate (typically of the order of parts per million) can be achieved without affecting the focus of the projection beam on the substrate surface to an unacceptable extent. Although focus change due to displacement of the microlens array towards or away from the substrate is a first order effect, and resultant changes in magnification on a second order effect, nevertheless useful magnification adjustment may be made.

In this embodiment, the field lens may be made up of a single or two or more lenses. Each field lens may be simply moved in translation either towards or away from the microlens array, or the field lens may be tilted so as to result in a differential change in magnification across the surface of the exposed substrate. Similarly, the microlens array may be moved in translation and/or tilted.

The term “array of individually controllable elements” as here employed should be broadly interpreted as referring to any device that can be used to endow an incoming radiation beam with a patterned cross-section, so that a desired pattern can be created in a target portion of the substrate. The terms “light valve” and “Spatial Light Modulator” (SLM) can also be used in this context. Examples of such patterning devices are discussed below.

A programmable mirror array may comprise a matrix-addressable surface having a viscoelastic control layer and a reflective surface. The basic principle behind such an apparatus is that, for example, addressed areas of the reflective surface reflect incident light as diffracted light, whereas unaddressed areas reflect incident light as undiffracted light. Using an appropriate spatial filter, the undiffracted light can be filtered out of the reflected beam, leaving only the diffracted light to reach the substrate. In this manner, the beam becomes patterned according to the addressing pattern of the matrix-addressable surface.

It will be appreciated that, as an alternative, the filter may filter out the diffracted light, leaving the undiffracted light to reach the substrate. An array of diffractive optical micro electrical mechanical system (MEMS) devices can also be used in a corresponding manner. Each diffractive optical MEMS device can include a plurality of reflective ribbons that can be deformed relative to one another to form a grating that reflects incident light as diffracted light.

A further alternative embodiment can include a programmable mirror array employing a matrix arrangement of tiny mirrors, each of which can be individually tilted about an axis by applying a suitable localized electric field, or by employing piezoelectric actuation means. Once again, the mirrors are matrix-addressable, such that addressed mirrors will reflect an incoming radiation beam in a different direction to unaddressed mirrors; in this manner, the reflected beam is patterned according to the addressing pattern of the matrix-addressable mirrors. The required matrix addressing can be performed using suitable electronic means.

In both of the situations described here above, the array of individually controllable elements can comprise one or more programmable mirror arrays. More information on mirror arrays as here referred to can be gleaned, for example, from U.S. Pat. Nos. 5,296,891 and 5,523,193, and PCT patent applications WO 98/38597 and WO 98/33096, which are incorporated herein by reference in their entireties.

A programmable LCD array can also be used. An example of such a construction is given in U.S. Pat. No. 5,229,872, which is incorporated herein by reference in its entirety.

It should be appreciated that where pre-biasing of features, optical proximity correction features, phase variation techniques and multiple exposure techniques are used, for example, the pattern “displayed” on the array of individually controllable elements may differ substantially from the pattern eventually transferred to a layer of or on the substrate. Similarly, the pattern eventually generated on the substrate may not correspond to the pattern formed at any one instant on the array of individually controllable elements. This may be the case in an arrangement in which the eventual pattern formed on each part of the substrate is built up over a given period of time or a given number of exposures during which the pattern on the array of individually controllable elements and/or the relative position of the substrate changes.

Although specific reference may be made in this text to the use of lithographic apparatus in the manufacture of ICs, it should be understood that the lithographic apparatus described herein may have other applications, such as, for example, the manufacture of DNA chips, MEMS, MOEMS, integrated optical systems, guidance and detection patterns for magnetic domain memories, flat panel displays, thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “projection system” used herein should be broadly interpreted as encompassing various types of projection systems, including refractive optical systems, reflective optical systems, and catadioptric optical systems, as appropriate, for example, for the exposure radiation being used, or for other factors such as the use of an immersion fluid or the use of a vacuum. Any use of the term “lens” herein may be considered as synonymous with the more general term “projection system.”

The illumination system may also encompass various types of optical components, including refractive, reflective, and catadioptric optical components for directing, shaping, or controlling the projection beam of radiation, and such components may also be referred to below, collectively or singularly, as a “lens.”

The lithographic apparatus may be of a type having two (e.g., dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index (e.g., water), so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

Further, the apparatus may be provided with a fluid processing cell to allow interactions between a fluid and irradiated parts of the substrate (e.g., to selectively attach chemicals to the substrate or to selectively modify the surface structure of the substrate).

Lithographic Projection Apparatus

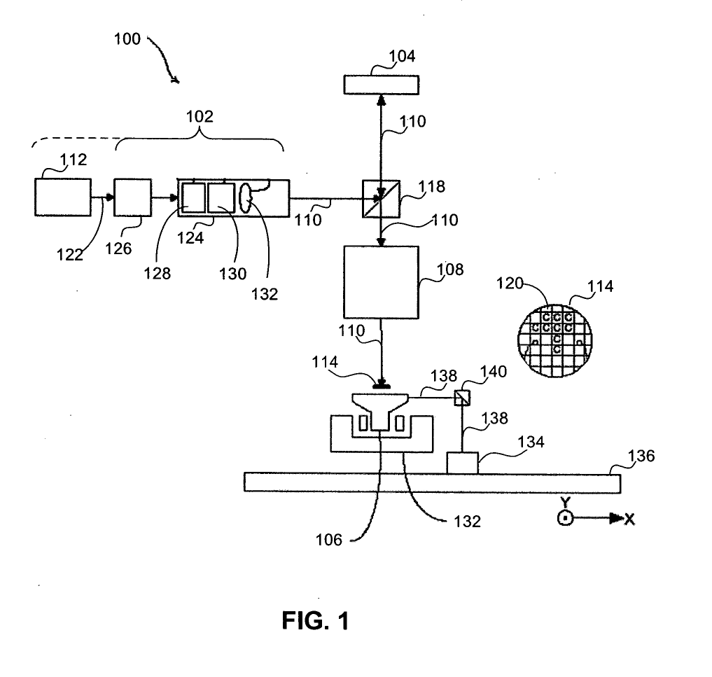

FIG. 1 schematically depicts a lithographic projection apparatus 100 according to an embodiment of the invention. Apparatus 100 includes at least a radiation system 102, an array of individually controllable elements 104, an object table 106 (e.g., a substrate table), and a projection system (“lens”) 108.

Radiation system 102 can be used for supplying a projection beam 110 of radiation (e.g., UV radiation), which in this particular case also comprises a radiation source 112.

An array of individually controllable elements 104 (e.g., a programmable mirror array) can be used for applying a pattern to projection beam 110. In general, the position of the array of individually controllable elements 104 can be fixed relative to projection system 108. However, in an alternative arrangement, an array of individually controllable elements 104 may be connected to a positioning device (not shown) for accurately positioning it with respect to projection system 108. As here depicted, individually controllable elements 104 are of a reflective type (e.g., have a reflective array of individually controllable elements).

Object table 106 can be provided with a substrate holder (not specifically shown) for holding a substrate 114 (e.g., a resist-coated silicon wafer or glass substrate) and object table 106 can be connected to a positioning device 116 for accurately positioning substrate 114 with respect to projection system 108.

Projection system 108 (e.g., a quartz and/or CaF₂ lens system or a catadioptric system comprising lens elements made from such materials, or a mirror system) can be used for projecting the patterned beam received from a beam splitter 118 onto a target portion 120 (e.g., one or more dies) of substrate 114. Projection system 108 may project an image of the array of individually controllable elements 104 onto substrate 114. Alternatively, projection system 108 may project images of secondary sources for which the elements of the array of individually controllable elements 104 act as shutters. Projection system 108 may also comprise a micro lens array (MLA) to form the secondary sources and to project microspots onto substrate 114.

Source 112 (e.g., an excimer laser) can produce a beam of radiation 122. Beam 122 is fed into an illumination system (illuminator) 124, either directly or after having traversed conditioning device 126, such as a beam expander 126, for example. Illuminator 124 may comprise an adjusting device 128 for setting the outer and/or inner radial extent (commonly referred to as σ-outer and σ-inner, respectively) of the intensity distribution in beam 122. In addition, illuminator 124 will generally include various other components, such as an integrator 130 and a condenser 132. In this way, projection beam 110 impinging on the array of individually controllable elements 104 has a desired uniformity and intensity distribution in its cross-section.

It should be noted, with regard to FIG. 1, that source 112 may be within the housing of lithographic projection apparatus 100 (as is often the case when source 112 is a mercury lamp, for example). In alternative embodiments, source 112 may also be remote from lithographic projection apparatus 100. In this case, radiation beam 122 would be directed into apparatus 100 (e.g., with the aid of suitable directing mirrors). This latter scenario is often the case when source 112 is an excimer laser. It is to be appreciated that both of these scenarios are contemplated within the scope of the present invention.

Beam 110 subsequently intercepts the array of individually controllable elements 104 after being directing using beam splitter 118. Having been reflected by the array of individually controllable elements 104, beam 110 passes through projection system 108, which focuses beam 110 onto a target portion 120 of the substrate 114.

With the aid of positioning device 116 (and optionally interferometric measuring device 134 on a base plate 136 that receives interferometric beams 138 via beam splitter 140), substrate table 106 can be moved accurately, so as to position different target portions 120 in the path of beam 110. Where used, the positioning device for the array of individually controllable elements 104 can be used to accurately correct the position of the array of individually controllable elements 104 with respect to the path of beam 110, e.g., during a scan. In general, movement of object table 106 is realized with the aid of a long-stroke module (course positioning) and a short-stroke module (fine positioning), which are not explicitly depicted in FIG. 1. A similar system may also be used to position the array of individually controllable elements 104. It will be appreciated that projection beam 110 may alternatively/additionally be moveable, while object table 106 and/or the array of individually controllable elements 104 may have a fixed position to provide the required relative movement.

In an alternative configuration of the embodiment, substrate table 106 may be fixed, with substrate 114 being moveable over substrate table 106. Where this is done, substrate table 106 is provided with a multitude of openings on a flat uppermost surface, gas being fed through the openings to provide a gas cushion which is capable of supporting substrate 114. This is conventionally referred to as an air bearing arrangement. Substrate 114 is moved over substrate table 106 using one or more actuators (not shown), which are capable of accurately positioning substrate 114 with respect to the path of beam 110. Alternatively, substrate 114 may be moved over substrate table 106 by selectively starting and stopping the passage of gas through the openings.

Although lithography apparatus 100 according to the invention is herein described as being for exposing a resist on a substrate, it will be appreciated that the invention is not limited to this use and apparatus 100 may be used to project a patterned projection beam 110 for use in resistless lithography.

The depicted apparatus 100 can be used in four preferred modes:

1. Step mode: the entire pattern on the array of individually controllable elements 104 is projected in one go (i.e., a single “flash”) onto a target portion 120. Substrate table 106 is then moved in the x and/or y directions to a different position for a different target portion 120 to be irradiated by patterned projection beam 110.

2. Scan mode: essentially the same as step mode, except that a given target portion 120 is not exposed in a single “flash.” Instead, the array of individually controllable elements 104 is movable in a given direction (the so-called “scan direction”, e.g., the y direction) with a speed v, so that patterned projection beam 110 is caused to scan over the array of individually controllable elements 104. Concurrently, substrate table 106 is simultaneously moved in the same or opposite direction at a speed V=Mv, in which M is the magnification of projection system 108. In this manner, a relatively large target portion 120 can be exposed, without having to compromise on resolution.

3. Pulse mode: the array of individually controllable elements 104 is kept essentially stationary and the entire pattern is projected onto a target portion 120 of substrate 114 using pulsed radiation system 102. Substrate table 106 is moved with an essentially constant speed such that patterned projection beam 110 is caused to scan a line across substrate 106. The pattern on the array of individually controllable elements 104 is updated as required between pulses of radiation system 102 and the pulses are timed such that successive target portions 120 are exposed at the required locations on substrate 114. Consequently, patterned projection beam 110 can scan across substrate 114 to expose the complete pattern for a strip of substrate 114. The process is repeated until complete substrate 114 has been exposed line by line.

4. Continuous scan mode: essentially the same as pulse mode except that a substantially constant radiation system 102 is used and the pattern on the array of individually controllable elements 104 is updated as patterned projection beam 110 scans across substrate 114 and exposes it.

Combinations and/or variations on the above described modes of use or entirely different modes of use may also be employed.

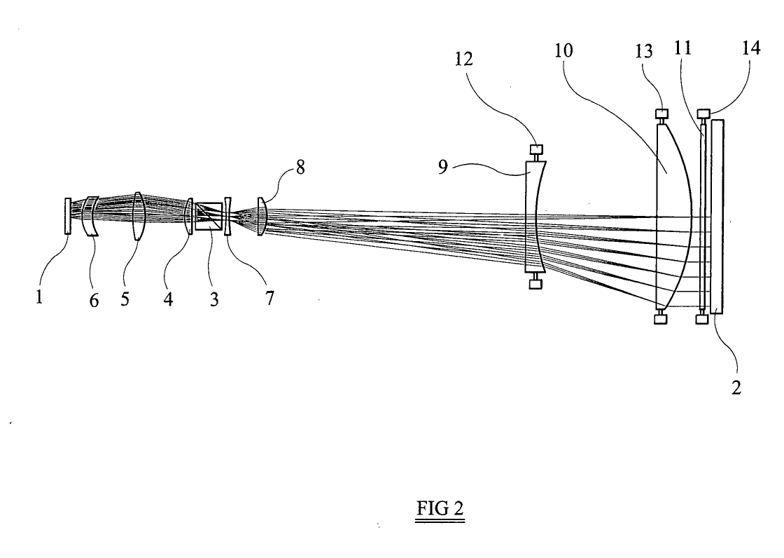

FIG. 2 shows an embodiment of the present invention of the illustrated in FIG. 1, but in greater detail. Array of individually controllable elements 104 of FIG. 1 corresponds to array 1 in FIG. 2, and substrate 114 in FIG. 1 corresponds to substrate 2 in FIG. 2.

In the example shown in FIG. 2, a beam of radiation (not shown) is reflected by a beam splitter 3 towards array 1 via a series of lenses 4, 5 and 6. Light is then reflected back from array 1 through lenses 6, 5 and 4 and then through beam splitter 3. Light emerging from the beam splitter 3 passes through a beam expander, defined by lenses 7, 8, 9 and 10, and through a microlens array 11, which focuses a series of spots of light on substrate 2. Lenses 7 and 8 expand the beam emerging from beam splitter 3. Lenses 9 and 10 serve as a field lens, which generates a substantially parallel beam at microlens array 11. This creates a nominally telecentric optical system. Lenses 9, 10 and 11 are supported in frames 12, 13 and 14, the positions of which are adjustable so that small displacements of lenses 9, 10, and 11 can be made in a controlled manner. In the case illustrated in FIG. 2, a pupil is defined in a plane occupied by lens 7.

Displacement actuators (not shown) are attached to frames 12, 13 and 14 and used to adjust the positions of lenses 9, 10 and 11. These actuators are used to adjust
the height and/or tilt of the lenses. The actuators can be, but are not limited to, electro-mechanical, electromagnetic, thermal, piezoelectric or operate in any convenient manner to accurately control lens position. Actuator drives (not shown) will receive displacement control information from a control system, as further described below. The amount of displacement of the lenses is measured and controlled using a feedback control arrangement (not shown). Also, there is a algorithm relating the positions of the lenses to the magnification. This algorithm can be modelled by simulation or experiment, as further described below. Exemplary Array of Individual Controllable Elements

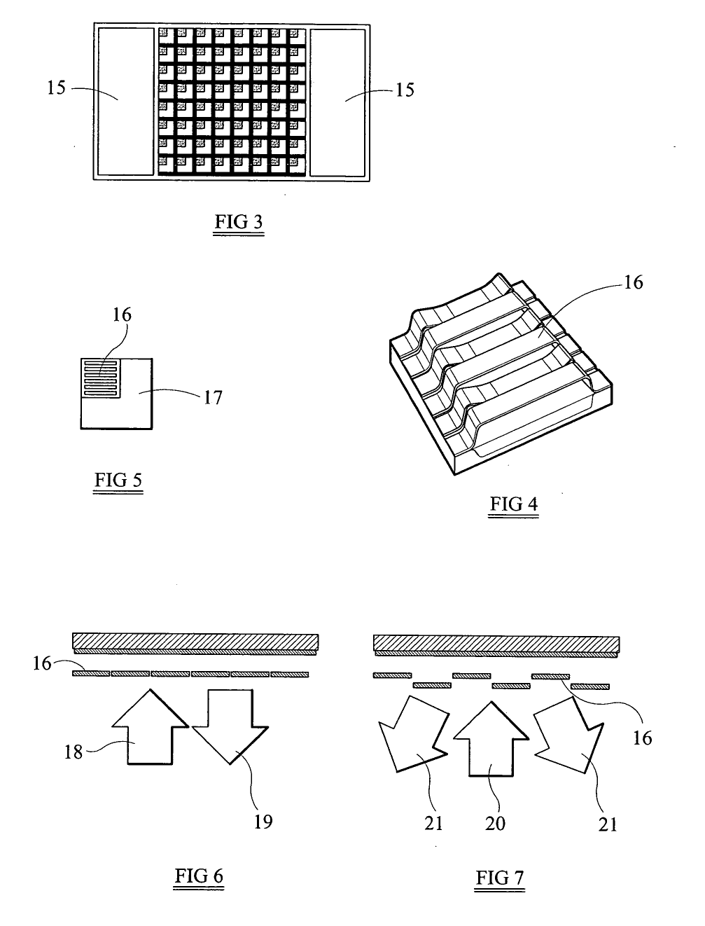

Referring now to FIGS. 3 to 7, further details of array 1 of individually controllable elements are illustrated. Array 1 comprises an array of spatial light modulators (FIG. 3). The general characteristics of spatial light modulators are described, for example, in U.S. Pat. No. 5,311,360, which is incorporated herein by reference in its entirety.

In the example shown in FIG. 3, the spatial light modulator comprises an 8×8 array of elements, which can be individually controlled by drivers defined in regions 15 of array 1. Of course, in an alternative embodiment, a much larger array would be used, for example a 512×512 or 1024×1024 array. Each element of array 1 comprises a series of elongate displaceable members 16 (FIG. 4). Displaceable members 16 are controllable by sample and hold circuits 17 located adjacent the displaceable members 16 (FIG. 5).

In the example shown in FIGS. 4 and 5, each element corresponds to a single pixel of a pattern to be imparted to a projection beam directed onto the array. Displaceable members 16 will normally adopt a coplanar configuration so as to define a mirror. This is represented in FIG. 6 where an arrow 18 represents incident light and an arrow 19 reflected light.

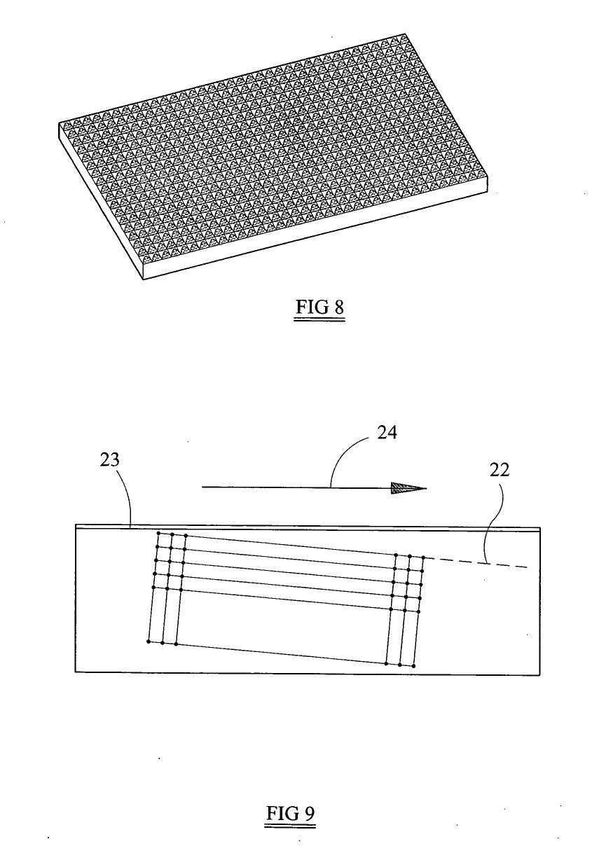

FIG. 7 shows how displaceable members 16 may be moved to desired positions when a bias voltage is applied to each element, according to one embodiment of the present invention. In this condition, incident light represented by an arrow 20 is not simply reflected, but rather diffracted as indicated by arrows 21. Such diffracted light is not directed back through the optical system towards substrate 1 to be exposed. Thus, a desired pattern can be imparted to a beam of light delivered to lenses 7, 8, 9, 10 and 11 of FIG. 2.

Exemplary Microlens Array

FIG. 8 shows a structure of a microlens array, according to one embodiment of the present invention. For example, the structure shown corresponds to component 11 of FIG. 2. Essentially a microlens array comprises a large number of very small lenses each of which is intended to focus a single pixel of light onto substrate 2.

FIG. 9 schematically represents a matrix of dots projected onto substrate 2, according to one embodiment of the present invention.

Referring to FIGS. 8 and 9, the optical system is arranged such that the matrix of dots is aligned with a direction indicated by broken line 22, which is inclined to a direction represented by line 23, which is parallel to the system scan direction. For example, the direction 24 in which substrate 2 is displaced beneath the microlens array. It is therefore possible to build up a desired exposure pattern on the substrate by appropriate control of individual pixels as the substrate is displaced beneath the microlens array in the direction of arrow 24.

Exemplary Configurations to Use Field Lens to Change Projection Beam

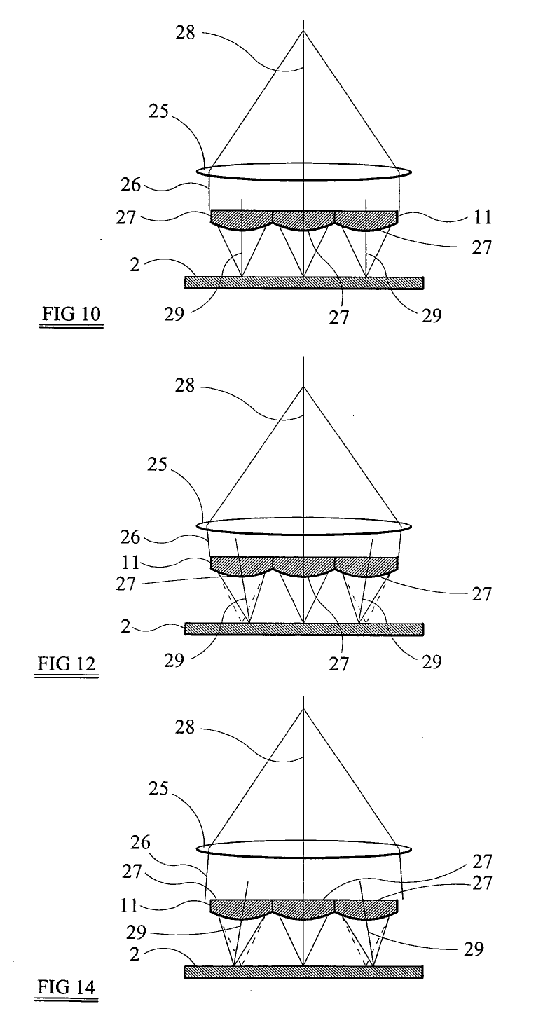

FIG. 10 schematically shows a substrate 2 located beneath the microlens array 11, according to one embodiment of the present invention. In this embodiment, a field lens 25 has a single lens. It will be appreciated that a field lens may comprise a single lens as shown in FIG. 10, two lenses shown in FIG. 2, or more than two lenses. However, in all these examples the purpose of the field lens is to generate a projection beam that is substantially parallel. In this embodiment, a projection beam 26 is shown. Projection beam 26 illuminates each individual lens elements 27 of microlens array 11. While any number of elements 27 can be used based on a desired application, in this figure only three of the elements 27 are shown.

Microlens array 11 extends perpendicular to beam 26 and parallel to a surface of substrate 2 that is to be exposed. The spacing between microlens array 11 and substrate 2 is such that each pixel in array 104 (FIG. 1) or array 1 (FIG. 2) is focused on the surface of substrate 2. A main optical axis 28 of the projection system is parallel to lines 29 of each of lenses 27 (lines 29 may also represent the direction in which light is directed towards substrate 2 from each of lens 27 of microlens array 11). In this figure, the projection system defines a pupil corresponding to the plane at which the illustrated rays intersect axis 28 above field lens 25.

FIG. 11 is a schematic view of the top surface of array 11 showing a 3×3 array of lenses when the embodiment of FIG. 10 is used. A periphery of one lens is indicated by a circle 30, a outer periphery of an illumination beam that projects onto that lens is indicated by circle 31, and a position on underlying substrate of an image spot focused by that lens is indicated by circle 32. In this embodiment, circles 30, 31, and 32 are concentric. The magnification is a function of the spacing between the image spots on the substrate, which in this embodiment is identical to the spacing of the lenses in array 11.

In some circumstances it may be desired to adjust the magnification of the optical system to compensate for distortions in the substrate surface. For example, if the substrate dimensions are affected by thermal expansion or contraction, it would be desirable to be able to match that thermal expansion or contraction by making small adjustments to the magnification of the optical system.

In accordance with one embodiment of the present invention, this can be achieved by adjusting the position of field lens 25, by adjusting the position of lens array 11, by adjusting the positions of both field lens 25 and lens array 11. Small displacements of field lens 25 will not result in first order changes in resolution since field lens 25 is typically a relatively weak lens. It will however bring the spots projected by microlens array 11 closer together (if the magnification is reduced) or further apart (if the magnification is increased). Similarly, small movements of array 11 can adjust the magnification without too great a loss of focus at the substrate surface.

FIG. 12 shows a response of the optical system to a small displacement of field lens 25 in the direction towards microlens array 11. There is no change in the position of the spot projected by microlens array 11 on optical axis 28 of the overall system, but lines 29 are inclined inwards towards optical axis 28 in the direction towards substrate 2.

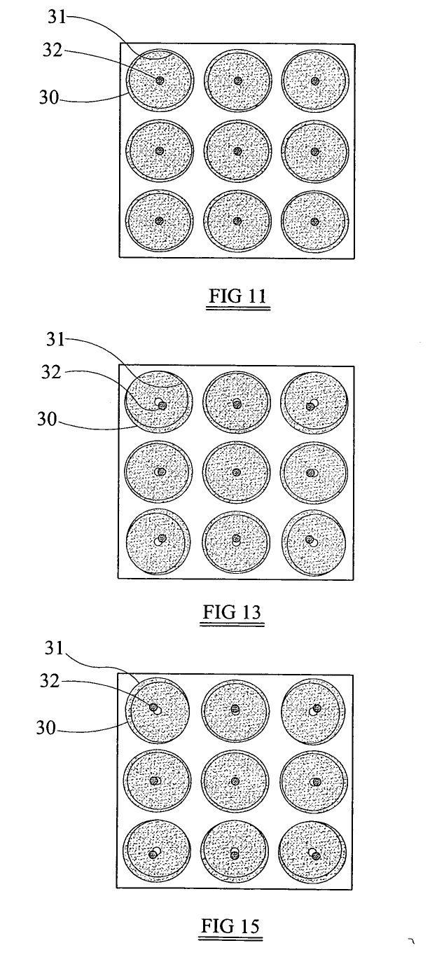

FIG. 13 shows the displacement of periphery circles 30 of the illuminating beamlets and image spots 32 relative to lens circles 31 of array 11. The positions of image spots 32 are shown superimposed on the corresponding positions of image spots 32 (shown as unshaded circles) in FIG. 11. This shows that there is an effective reduction in the magnification of the optical system. Although there is some loss of focus, the overall effect is not very great assuming that the inclination of lines 29 is relatively small. Thus, small changes in the magnification range (of the order of 15 parts per million) can be readily achieved by displacing of field lens 25.

FIGS. 14 and 15 show the result of moving field lens 25 away from microlens array 11. A displacement of field lens 25 in this way results in lines 29 being inclined outwards relative to axis 28 in the direction towards substrate 2. Thus, FIGS. 14 and 15 show a small increase in the magnification of the overall optical system.

It will be appreciated that the displacement of lines 29 as shown in FIGS. 11 and 12 has been greatly exaggerated in order to make the explanation clearer as compared to angular inclination of lines 29 that will result in practice, assuming a change in magnification of the order of 15 parts per million. The range of magnification change may be only a few ppm, or more than 15 ppm, for example 100 ppm.

It will also be appreciated that, whereas in FIGS. 10 to 15 a single field lens 25 is shown, more than one field lens can be provided. For example, in FIG. 2 where two field lenses 9 and 10 are provided, each of which may be displaced on support frames 12 and 13 to achieve the appropriate change in magnification.

In the examples illustrated in FIGS. 12 and 14, field lens 25 is displaced in a direction parallel to main optical axis 28. The result is a change in magnification which is uniform across the entire area of substrate 2. It is to be appreciated that in other examples it may be desirable to make adjustments to the magnification, which vary across substrate 2. For example, this can be as a result of a temperature gradient across a large substrate similar to a type used for manufacturing large-scale liquid crystal displays.

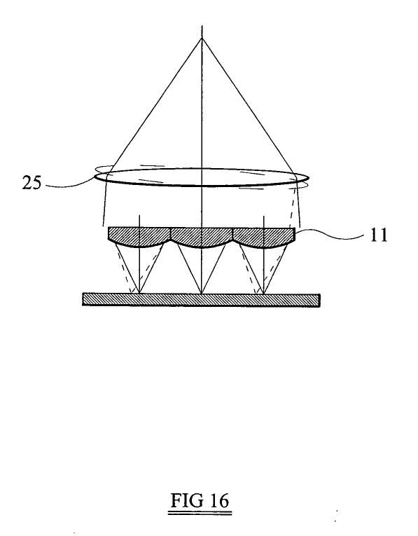

FIG. 16 two possible positions of field lens 25 are shown (one in full lines, one in broken lines) with two resultant sets of image spots, according to one embodiment of the present invention. In this embodiment, field lens 25 could be tilted relative to optical axis 28 so as to reduce the magnification at one side of array 11 and increase the magnification at the other side of array 11 with the magnification adjustment between the two sides of array 11 varying with position across array 11.

The effects of moving field lens 25 while lens array 11 is not moved are illustrated in FIGS. 10 to 16.

As shown in FIG. 2, it is also possible to displace lens array 11 by displacing frame 14.

In an example where illumination beam between lens 13 and lens array 11 is not perfectly parallel, axial displacement of array 11 will result in a change in magnification similar to that which will result if lens 13 was displaced axially. Axial movement of lens array 11 would result in some loss of focus, but if this was considered to be excessive this could be compensated for by adjustment of the position of substrate 2 in the axial direction. Similarly, tilting of lens array 11 to change the inclination of array 11 relative to the optical axis will result in a change in magnification which varies across the substrate.

Thus the invention provides the possibility of making small, but potentially critically significant adjustments to the magnification in lithographic apparatus relying upon microlens arrays.

Exemplary Operation

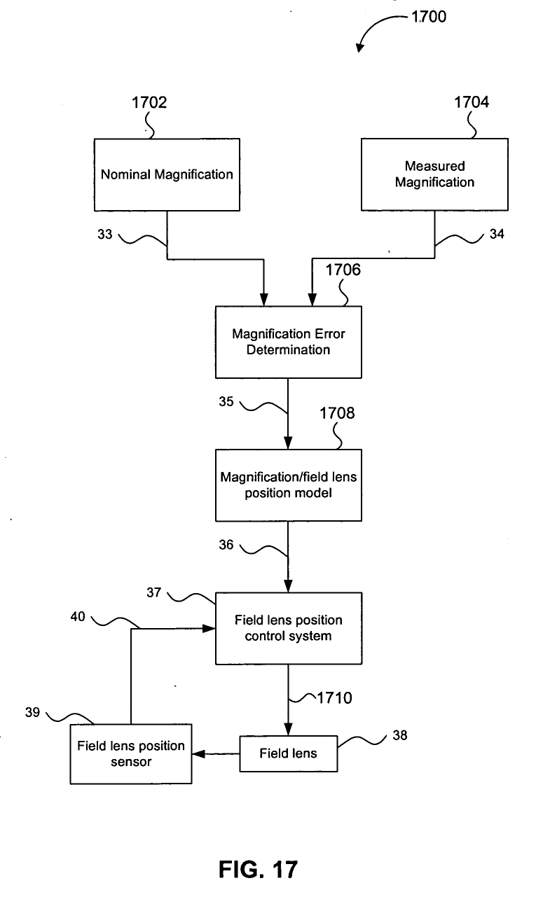

FIG. 17 is a flow diagram illustrating a magnification control process 1700, according to one embodiment of the present invention. In this embodiment, displacement of only a field lens is performed. It is to be appreciated that this method can be performed by one of the above systems, or other lithographic systems.

In step 1702, a nominal desired magnification is calculated to produce a nominal magnification output 33. Light is then projected through a projection system with the field lens in a predetermined nominal position. In step 1704, an actual magnification is measured to produce a measured magnification output 34. In one example this can be done using alignment sensors. In step 1706, nominal magnification output 33 and measured magnification output 34 are compared to generate a magnification error output 35 representing the change in magnification required to achieve the nominal magnification.

In step 1708, magnification error output 35 is input to a previously derived model of a relationship between magnification and field lens position. In this step, the model is then used to generate an actuator control output 36 representing a desired actuator position corresponding to a desired field lens position, which if achieved will reduce the magnification error to zero. Output 36 is applied to a field lens position control system 37, which outputs a signal 1710 that is used to displace a field lens 38 to a position indicated by actuator control output 36. An actual field lens position is measured by a field lens position displacement sensing system 39, which generates an output 40. Out put signal 40 is used as a feedback control signal that is received by actuator control system 37. Feedback control signal 40 ensures that the actual field lens position corresponds to the desired field lens position represented by the output 36.

In various embodiments, the model of the relationship between magnification and field lens position can be derived by simulation or experiment, as discussed below.

In one embodiment, based on the design of the optical projection system, it is possible to simulate the performance of that projection system. This can be done to calculate the non-telecentricity of the system as a function of the position of the field lens with respect to the pupil of the projection optics, which is the position with respect to the beam expander. In this embodiment, the magnification of the projection system at substrate level can be derived from the non-telecentricity, the geometry of the lens array, and the position of the lens array with respect to the field lens. Thus, the model of the relationship between positions of the field lens and the lens array can be obtained. This model is then programmed into the control system, e.g. as a look up table. This model is then used as described with reference to FIG. 17 to control the movement of the actuators which adjust the position of the field lens.

In another embodiment, experimentation rather than simulation can be used. The relationship between a field lens position change and a resultant magnification change is measured using a metrology system. Repeating this process, a range of positions and magnifications corresponding to those positions is measured. A look up table is obtained from these measurements. This look up table is programmed into the control system. During operation of the exposure system, the look up table, together with the magnification errors measured by the system, provides inputs to the actuators to move the field lens. Thus magnification errors are corrected. This experiment can be performed periodically, and the look up table updated periodically, in order to compensate for machine drift.

It will be appreciated that, although the embodiment of the invention described with reference to FIG. 2 uses a diffraction optical (MEMS) device as an example, other contrast devices may be used and any variable contrast device or controllable transmissive pattern-imparting device could be used to apply the appropriate pattern to the beam that is projected through the adjustable field lens and the adjustable lens array. Similarly, any appropriate design of beam expander, for example refractive or reflective, could be used. All such variations and permutations are contemplated within the scope of the present invention.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A lithographic apparatus, comprising:
an illumination system that supplies a projection beam of radiation;
a patterning system that patterns the projection beam;
a substrate table that supports a substrate; and
a projection system that projects the patterned beam onto a target portion of the substrate and defines a pupil between the patterning system and the substrate table, the projection system comprising,
a series of lens components located between the pupil and the substrate table, the lens components comprising,
a beam expander that expands the patterned beam from the pupil, and
an array of lenses extending transversely relative to the patterned beam, such that each lens of the array of lenses focuses a respective portion of the patterned beam onto a respective part of the target portion of the substrate,
wherein a position of at least one of the lens components is adjustable relative to the pupil to adjust a magnification of the projection system.

2. The apparatus of claim 1, wherein at least one lens component of the beam expander is displaceable relative to the pupil and the array of lenses.

3. The apparatus of claim 1, wherein the array of lenses is displaceable relative to the pupil and the beam expander.

4. The apparatus of claim 1, wherein at least one lens component of the beam expander and the array of lenses are both displaceable relative to the pupil.

5. The apparatus of claim 1, wherein the beam expander generates a substantially parallel beam of radiation between itself and the array of lenses.

6. The apparatus of claim 1, wherein a single lens component of the beam expander is displaceable relative to the pupil.

7. An apparatus according to claim 1, wherein at least two lens components of the beam expander are displaceable relative to the pupil.

8. An apparatus according to claim 1, wherein a spacing between the array of lenses and at least one lens component of the beam expander is adjustable.

9. An apparatus according to claim 1, wherein an inclination of at least one lens component of the beam expander with respect to the patterned beam is adjustable.

10. An apparatus according to claim 1, wherein an inclination of the array of lenses with respect to the patterned beam is adjustable.

11. An apparatus according to claim 1, wherein the magnification is adjustable in a range of about Oppm to about 100 ppm.

12. A device manufacturing method, comprising:
forming individually controllable elements into an array of individually controllable elements;
using the array of individually controllable elements to impart a projection beam with a pattern;
projecting the patterned beam of radiation onto a target portion of a substrate through a projection system defining a pupil and comprising a series of lens components located between the pupil and a substrate table;
using a beam expander, which is part of the lens components, to expand the patterned beam from the pupil and a lens array extending transversely relative to the patterned beam;
focusing a respective part of the patterned beam using each lens in the lens array onto a respective part of the target portion of the substrate; and
adjusting a magnification of the projection system by adjusting a position of at least one of the lens components relative to the pupil.

13. The method of claim 12, further comprising displacing at least one lens component of the beam expander relative to the pupil and the lens array.

14. The method of claim 12, further comprising displacing the lens array relative to the pupil and the beam expander.

15. The method of claim 12, further comprising displacing at least one lens component of the beam expander and the lens array relative to the beam expander.

16. The method of claim 12, further comprising positioning the beam expander to generate a substantially parallel beam of radiation between itself and the lens array.

17. The method of claim 12, further comprising adjusting a position of a single lens component of the beam expander.

18. The method of claim 12, further comprising adjusting positions of at least two lens components of the beam expander.

19. The method of claim 12, further comprising adjusting a spacing between the beam expander and the lens array.

20. The method of claim 12, further comprising adjusting an inclination of the at least one component of the beam expander with respect to the projection beam.

21. The method of claim 12, further comprising adjusting an inclination of the lens array with respect to the projection beam.
